(19) United States
(12) Patent Application Publication
(10) Pub. No.: US 2020/0298608 A1
(43) Pub. Date: Sep. 24, 2020

(54) A SECURITY DOCUMENT

(71) Applicant: DE LA RUE INTERNATIONAL LIMITED, Basingstoke Hampshire (GB)

(72) Inventor: Matthew SUGDON, Basingstoke Hampshire (GB)

(73) Assignee: DE LA RUE INTERNATIONAL LIMITED, Basingstoke Hampshire (GB)

(21) Appl. No.: 16/087,370

(22) PCT Filed: Mar. 22, 2017
(86) PCT No.: PCT/GB2017/050804

§ 371 Date: Sep. 21, 2018

(30) Foreign Application Priority Data
Mar. 23, 2016 (GB) 1604947.0
Jul. 13, 2016 (GB) 1612152.7

(51) Int. Cl. B42D 25/24; B42D 25/355; B42D 25/47; B42B 2/00; C08L 69/00; B32B 7/12; B32B 27/08; B32B 37/12; B32B 27/40; B32B 27/38; B32B 27/36; B32B 27/20

(52) U.S. Cl. CPC B42D 25/24; B42D 25/355; B42D 25/47; B42B 2/00; C08L 69/00; B32B 7/12; B42D 25/328; B32B 37/12; B32B 27/40; B32B 27/38; B32B 27/36; B32B 27/20; B32B 27/08

(57) ABSTRACT

A security document includes a first leaf having a first polymer substrate and a first reinforcement layer attached or formed with the first leaf. An outer leaf is attached to the first leaf along a fold line and is located between the first leaf and a cover. The first reinforcement layer extends along the first leaf at least partially along the fold line and at least partially away from the fold line on both sides of the fold line. The security document also has methods of manufacturing such a security document and a plurality of such security documents.

### CROSS REFERENCE TO RELATED APPLICATIONS

This application is a national stage application, filed under 35 U.S.C. § 371, of International Patent Application No. PCT/GB2017/050804, filed on Mar. 22, 2017, which is incorporated by reference herein in its entirety.

### BACKGROUND OF THE DISCLOSURE

### (1) Field of the Disclosure

The present disclosure is directed towards a security document comprising a first leaf comprising a first polymer substrate and a first reinforcement layer attached or formed with the first leaf. The present disclosure is further directed towards methods of manufacturing such a security document and a plurality of such security documents.

### (2) Description of the Related Art

Security documents and booklets, such as passports, passbooks, identification documents, certificates, licenses, cheque books and the like, commonly comprise one or more security pages on which information is provided. A passport booklet typically comprises a cover and a plurality of internal visa pages therebetween. Typically the visa pages are made from paper having a grammage of around 85 gsm and are sewn together along a stitch line. The cover is adhered to the outside of the visa pages and thereby protects the stitch line. At least one data page is typically located between one of the visa pages and the cover and contains printed personal data overlaid by a layer of polymer laminate, which is usually applied as a film or lacquer. This layer helps protect the data and prevent counterfeiting and fraudulent alteration. The data page may be formed from a fibrous substrate and may comprise security features, such as watermarks, laser perforations, security fibres, security threads, security print and the like.

Alternatively, the data page may be formed from a sheet comprising a plastic, which is typically polycarbonate. Plastic data pages are more durable than fibrous substrate data pages and are resistant to delamination by a counterfeiter. A plastic security sheet may comprise various security features, such as UV responsive arrangements, optically variable features, windowed or transparent features, laser-perforations, laser markings and tactile features. However, new and improved security features must be developed in order for security document issuing authorities to keep ahead of counterfeiting methods.

EP-B-2004421 discloses adding a reinforcement strip to the outer cover sheet of the internal pages. This is in order to protect the exposed stitch line and to reinforce the entire booklet attached inside the cover. The reinforcing strips cover the stitch line and prevent them from any inadvertent damage.

### SUMMARY

The present invention is therefore generally directed towards the incorporation of a polymer substrate, which is preferably substantially flexible, into a multi-page security document. Such flexible polymer substrates are commonly used to form “polymer” banknotes and can contain a variety of security features. Objects of the present invention include overcoming difficulties in the incorporation of the flexible polymer substrate into a multi-page security document and enhancing the security and strength of security documents comprising the flexible polymer substrate. A further object is to provide an improved method of manufacture of the security document including the flexible polymer substrate.

The present invention therefore provides a security document comprising at least two leaves attached together along a fold line and a cover located on the outside of the at least two leaves, wherein the at least two leaves comprise: a first leaf comprising a first polymer substrate, wherein a first reinforcement layer is attached or formed with the first leaf, the first reinforcement layer extending along the first leaf at least partially along the fold line and at least partially away from the fold line on both sides of the fold line; and an outer leaf located between the first leaf and the cover.

The first reinforcement layer may be arranged such that if the first leaf is placed under tension from the fold line the reinforcement layer opposes the tension. In particular, the first reinforcement layer may be configured to prevent tearing along the fold line, which may comprise a stitch line through the at least two leaves. By virtue of including the reinforcement layer, the likelihood of tear initiation of the first polymer substrate can be reduced and/or it can be avoided. It is noted that this achieves a substantially different effect to that of the reinforcement strip of EP-B-2004421, which is directed to protecting the exposed stitch line.

The first polymer substrate is more durable than a fibrous substrate security sheet and is resistant to delamination by a counterfeiter. Furthermore, the first polymer substrate is thinner than a polycarbonate based data page and thus creates a more compact security document. Various different security features and devices may also be included in the first polymer substrate to increase the difficulty of counterfeiting it, whether by virtue of the security features alone or due to their interaction with security pages on adjacent pages.

Preferably the first reinforcement layer is visible when the security document is open. More preferably the first reinforcement layer is visible when the security document is open such that the first leaf is visible. The first leaf may comprise personal data and may form a data page of the security document. The first reinforcement layer may be visible when the security document is open such that the personal data located in or on the first leaf is visible. In all embodiments the first reinforcement layer may be visible on one or both of the first and second sides of the stitch line.

The first reinforcement layer may be located on the outer surface of first leaf adjacent the outer leaf and/or located on the inner surface of the first leaf and adjacent an inner second leaf. In a particular embodiment the first reinforcement layer is located on the outer surface of the first leaf and the personal data is located on the inner surface of the first leaf.

In a preferred embodiment the first reinforcement layer is transparent. Preferably at least one spine security feature is visible when the security document is open. In a preferred embodiment the first reinforcement layer is at least partially attached to the cover or outer leaf such that at least one spine security feature is hidden when the security document is open. In preferred embodiments the security document comprises a cover located on the outside of the first leaf and/or further leaves located on the inside of the first leaf, the cover and/or further leaves being attached to the fold line. Preferably the security document comprises an outer leaf attached to the fold line and located between the first leaf and cover, wherein an outer reinforcement layer is attached to the outer leaf about the fold line.

The present invention further provides a method of manufacturing a security document, the method comprising: forming a first leaf comprising a first polymer substrate; attaching to or forming with the first leaf a first reinforcement layer; attaching the first leaf to at least one further leaf along a fold line; and locating a cover on the outside of the first leaf and at least one further leaf, the at least one further leaf comprising an outer leaf located between the first leaf and the cover, wherein the first reinforcement layer extends along the first leaf at least partially along the fold line and at least partially away from the fold line on both sides of the fold line.

### BRIEF DESCRIPTION OF THE DRAWINGS

By way of example only, embodiments of a security document and a method of manufacture in accordance with the present invention are now described with reference to, and as shown in, the accompanying drawings, in which:

FIG. 1 is a perspective view of a passport according to the present invention in an open configuration;

FIG. 2 is a plan view of the passport of FIG. 1 opened between a first polymer page and an adjacent page;

FIG. 3 is a cross-sectional side elevation of the first polymer page of FIG. 2 through section A-A;

FIG. 4 is a plan view of the passport of FIG. 2 opened between the first polymer page and a cover;

FIG. 5 is a schematic cross-sectional side elevation of a fold line area of a security document according to the present invention;

FIG. 6 is a perspective view of a further embodiment of a security document of the present invention opened between a first leaf and a cover;

FIG. 7 is a perspective view of yet a further embodiment of a security document of the present invention opened between a first leaf and a cover;

FIG. 8 is a schematic cross-sectional side elevation of a fold line area of yet a further embodiment of a security document according to the present invention;

FIG. 9 is a perspective view of yet a further embodiment of a security document of the present invention opened between a first leaf and a cover;

FIG. 10 is a perspective view of a further embodiment of a passport according to the present invention opened between first and second polymer pages;

FIG. 11 is a perspective view of the passport of FIG. 10 opened between a first polymer page and an adjacent page;

FIG. 12 is a cross-sectional side elevation of the second polymer page of FIG. 10 through section B-B;

FIG. 13 is a plan view of the passport of FIG. 10 opened between the second polymer page and a cover; and

FIG. 14 is a schematic cross-sectional side elevation of a fold line area of the passport of FIG. 10.

### DETAILED DESCRIPTION OF THE DISCLOSURE

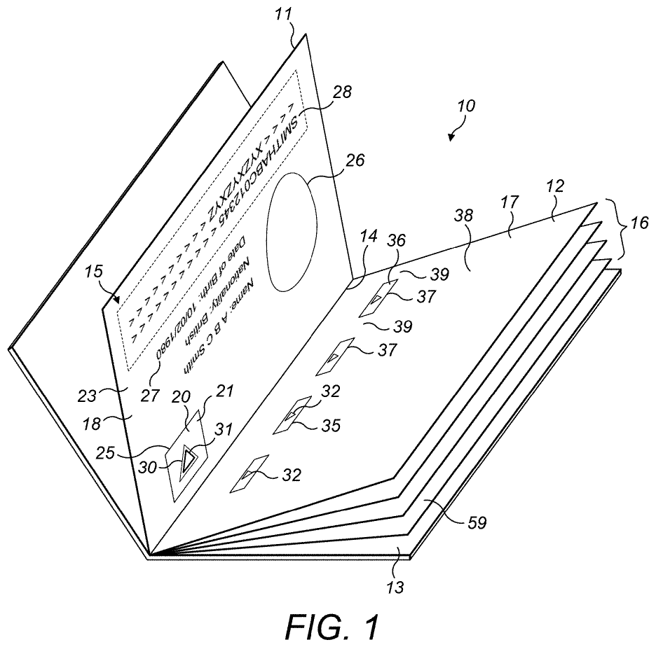

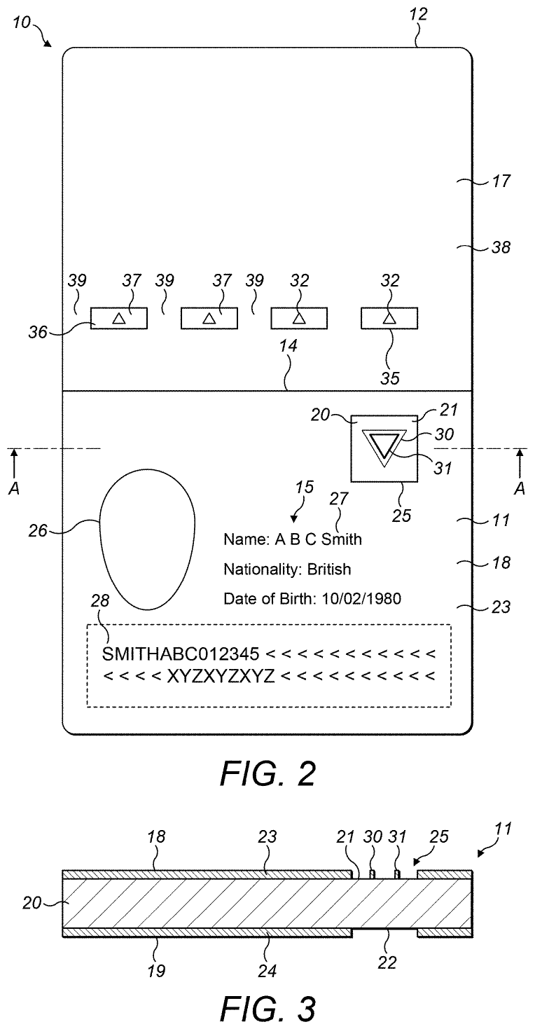

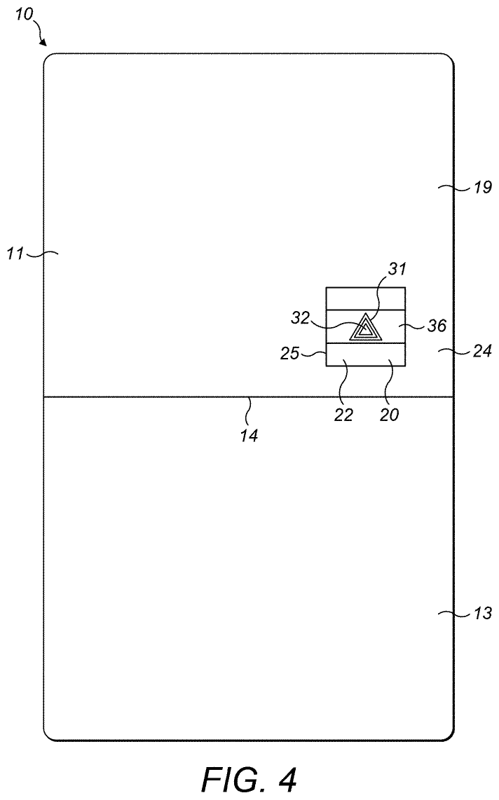

FIGS. 1 to 4 illustrate a security document 10 according to the present invention. The security document 10 in this case is a passport and comprises a first polymer page 11, an adjacent page 12 adjacent to the first polymer page 11 and a cover 13 attached together at edges such that they can pivot relative to one another. In the illustrated embodiment pages 11, 12 and cover 13 are attached along a fold line 14, which may be referred to as a hinge. The first polymer page 11 is, in this example, a data page which contains personal data 15 relating to the owner of the security document 10. The adjacent page 12 forms one of a plurality of visa pages 16, which are typically made from a fibrous substrate 17, such as paper, and may include a number of security features, such as security fibres and watermarks.

As illustrated in further detail in FIG. 3, the first polymer page 11 extends between first and second outer surfaces 18, 19 and comprises a first polymer substrate 20. The first polymer substrate 20 forms a main body of the first polymer page 11 and has first and second substrate surfaces 21, 22. The first polymer substrate 20 is preferably transparent such that a viewer can clearly see objects through it. However, the first polymer substrate 20 may be colourless or coloured, provided that it allows light to pass through it without significant scattering. The thickness of the first polymer substrate 20 is preferably in the range of from approximately 50 μm to approximately 100 μm, more preferably from approximately 60 μm to approximately 80 μm and most preferably approximately 70 μm.

The first polymer substrate 20 is formed from one or more polymeric materials, preferably a plastic and more preferably a thermoplastic. The polymeric materials may be synthetic and may, for example, comprise at least one of polypropylene (PP), bi-axially oriented PP (BOPP), polybutylene terephthalate (PBT), polyethylene terephthalate (PET), polyethylene (PE), polycarbonate (PC), polyvinyl chloride (PVC), nylon, acrylic, Cyclic Olefin Polymer (COP) or Cyclic Olefin Copolymer (COC). Suitable blends thereof include Teslin and a blend of PE and PP. BOPP is particularly suitable. The first polymer substrate 20 may be non-fibrous and may be non-porous. The first polymer substrate 20 may be monolithic and formed from a single type of material or may be multi-layered and have multiple layers of the same or different types of polymer.

At least one opacifying layer 23, 24 is located on the first and/or second substrate surface 21, 22 and defines or surrounds at least one window 25 of the first polymer page 11. The first polymer substrate 20 may contain no opacifying region or layer within it. The full window 25 is substantially transparent by virtue of being formed from just the transparent first polymer substrate 20.

The at least one opacifying layer 23, 24 is substantially opaque to substantially prevent light transmitting through the first polymer page 11. The at least one opacifying layer 23, 24 comprises a substantially non-transparent material and provides a suitable background for graphics and the personal data 15 located on it. The at least one opacifying layer 23, 24 may comprise a polymeric, non-fibrous material containing at least a light scattering substance such as a pigment. For example, the at least one opacifying layer 23, 24 may comprise a resin, such as a polyurethane based resin, polyester based resin or an epoxy based resin, and an opacifying pigment, such as titanium dioxide, silica, zinc oxide, tin oxide, clays or calcium carbonate. The at least one opacifying layer 23, 24 preferably covers at least a majority of the first and/or second substrate surface 21, 22.

The first polymer page 11 may further comprise an intermediate layer (not shown in the drawings) between the first and/or second substrate surface 21, 22 of the first polymer substrate 20 and the first and/or second opacifying layer 23, 24.

The personal data 15, in the form of a plurality of alphanumeric characters, is located in or on the first and/or second opacifying layer 23, 24. The personal data 15 may include, for example, the holder's portrait 26, text 27 providing the holder's name, nationality and date of birth and a machine readable zone 28 containing data for machine reading. The personal data 15 is known as “variable data” or “biographical data” and identifies the specific holder of the security document 10. The Seventh Edition (2015) of Document 9303 (“Machine Readable Travel Documents”) issued by the International Civil Aviation Organization (ICAO) describes such biographical data and its contents are incorporated herein by reference. Typically, no two security documents 10 issued by an issuing authority contain the same personal data 15. The personal data 15 may be incorporated into the first polymer page 11 in any suitable manner, for example by comprising a printed ink or laser markings. Preferably the personal data 15 is applied to the at least one opacifying layer 23, 24 by UV cure inkjet printing.

The first polymer page 11 may further comprise at least one first security device 30, which may be at least partially located in the window 25. In the illustrated embodiment the first security device 30 comprises a first element 31 located entirely in the window 25. The first polymer page 11 may also comprise a number of other security features within the first polymer substrate 20 and/or on the at least one opacifying layer 23, 24 for authenticating the security document 10. A layer of graphics may also be provided on the at least one opacifying layer 23, 24, around or underneath the personal data 15.

The first polymer page 11 is substantially flexible, particularly by virtue of the relative thinness of the first polymer substrate 20. The thickness of the first polymer page 11, which is the distance between the first and second outer surfaces 18, 19 (i.e. including the first polymer substrate 20 and at least one opacifying layer 23, 24), is preferably in the range of from approximately 50 μm to approximately 200 μm and more preferably in the range of from approximately 50 μm to approximately 150 μm.

The adjacent page 12 may comprise at least one second security device 35 and the at least one second security device 35 comprises at least one second element 32. The second security device 35 may be applied and adhered to the opposing surface 38 or it may be at least partially embedded therein in any manner known in the art. In the illustrated embodiment the at least one second security device 35 comprises a security thread 36 incorporated in or applied to the fibrous substrate 17, having at least one exposed region 37 at a surface 38 of the fibrous substrate 17 opposing the first polymer page 11 and at least one bridge 39. The at least one bridge 39 comprises fibrous substrate 17 overlying the security thread 36 between exposed regions 37. The at least one second element 32, which may be print, is located on the exposed region 37 of the security thread 36.

The attachment of the first polymer page 11 and adjacent page 12 along the fold line 14 may be in any suitable form that enables them to rotate or pivot relative to one. For example, the security document 10 may comprise a line of stitching along the fold line 14, which may be constructed in a manner such as that which is disclosed in WO-A-2011/151638. The security document 10 may comprises a plurality of leaves forming the first polymer page 11, adjacent page 12 and the visa pages and attached along the line of stitching. At least one stitching thread may pass through the fibrous substrate 17 forming the plurality of visa pages 16 and the first polymer substrate 20 forming the first polymer page 11. All or part of the outer visa page 16 and first polymer substrate 20 may be adhered to the cover 13 to form the booklet.

The security document 10 further comprises a reinforcement arrangement 50 about the fold line 14 which is adapted to strengthen the attachment between the first polymer page 11 and the cover 13. Such strengthening may be beneficial since tear initiation in the first polymer substrate 20 may be caused by apertures formed by a stitch line and typically the first polymer substrate 20 has a high rate of tear propagation after tear initiation. This is different to the fibrous substrate 17, in which tears can be easily initiated but have a lower rate of propagation.

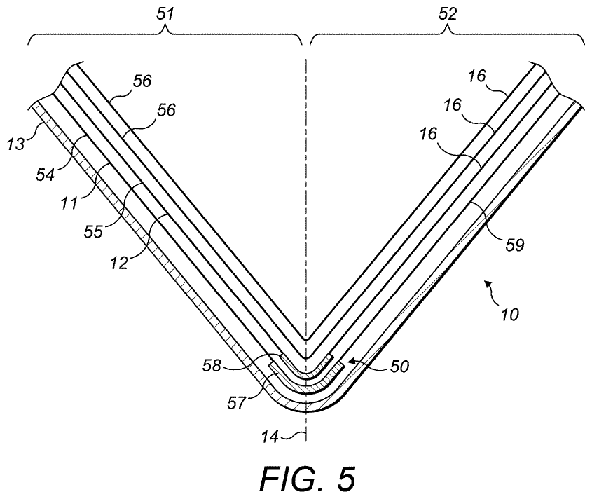

FIG. 5 illustrates a preferred embodiment of the reinforcement arrangement 50 in which the plurality of visa pages 16, first polymer page 11 and cover 13 are shown separated from one another, although in practice they are joined together. The security document 10 comprises a first side 51 and a second side 52 on either side of the fold line 14. The fold line 14 defines an axis about which the first and second sides 51, 52 can be rotated and brought together. The security document 10 comprises a first leaf 54, which is adjacent to the cover 13 and comprises the first polymer substrate 20 and the at least one opacifying layer 23, 24. The first leaf 54 therefore comprises the first polymer page 11, in this case the data page, at the first side 51 and a further polymer page 59 at the second side 52. The security document 10 comprises a second leaf 55 inwards of the first leaf 54 and which comprises the adjacent page 12 on the first side 51 and a visa page 16 on the second side 52. Further leaves 56 are located inwards of the second leaf 55 and form further visa pages 16 on the first and second sides 51, 52. It is noted that the cover 13 may be considered as a leaf in such an arrangement. FIG. 5 shows just two further leaves 56, but the security document 10 may comprise any suitable number of further leaves 56.

The reinforcement arrangement 50 comprises a first reinforcement layer 57 connected to the first leaf 54 about the fold line 14, preferably between the cover 13 and first leaf 54. In particular, the first reinforcement layer 57 comprises a strip of material extending at least partially along the length of the fold line 14. The first reinforcement layer 57 also extends at least partially away from the fold line 14 parallel to the first leaf 54, on both the first and second sides 51, 52 of the fold line 14 along the first polymer page 11 and further polymer page 59. The first reinforcement layer 57 is preferably arranged to effectively increase the thickness of the first leaf 54 about the holes formed by the stitches such that if the first leaf 54 is placed under tension the first reinforcement layer 57 resists the force rather than the first leaf 54, thereby preventing tear propagation around the stitch line. In addition to an increased thickness, the first reinforcement layer 57 may comprise a material that is more resistant to tear initiation than the first polymer substrate 20.

The term “strip” may refer to the first reinforcement layer 57 being relatively narrow in width, such as by extending away from the fold line 14 by a smaller distance than the first leaf 54. For instance, the first reinforcement layer 57 may extend along the first leaf 54 from one or both of the first and second sides 51, 52 of the fold line 14 by up to one half of, or more preferably up to one quarter of, the extension of the first leaf 54 away from the fold line 14. For example, the first reinforcement layer 57 may extend along the first polymer page 11 by up to one half, or by up to one quarter, of the width of the first polymer page 11.

The first reinforcement layer 57 is preferably at least 2 mm wide such that it covers any stitching of the fold line 14 and is easy to apply. The first reinforcement layer 57 may, for example, be in the range of approximately 2 mm to approximately 20 mm. The first reinforcement layer 57 may be located symmetrically about or offset from the fold line 14. The first reinforcement layer 57 may extend along at least approximately 50%, along at least approximately 75%, along at least approximately 90% or along substantially all of the length of the fold line 14.

The first reinforcement layer 57 may be attached to the first leaf 54 by welding (particularly ultrasonic welding), an adhesive (such as pressure sensitive adhesive) or the like. The first reinforcement layer 57 is preferably attached directly to the first polymer substrate 20, for example by leaving an area of its first and second substrate surfaces 21, 22 uncovered by the at least one opacifying layer 23, 24 and, if present, intermediate layer. As a result, the first reinforcement layer 57 can be attached directly to main structure of the first leaf 54 such that a stronger weld, adherence or the like is formed. However, in other embodiments the first reinforcement layer 57 may be attached to the at least one opacifying layer 23, 24 and, if present, intermediate layer.

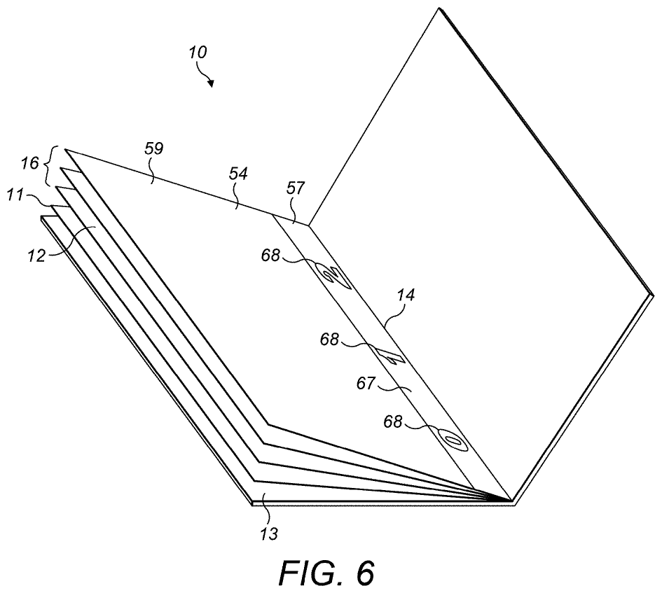

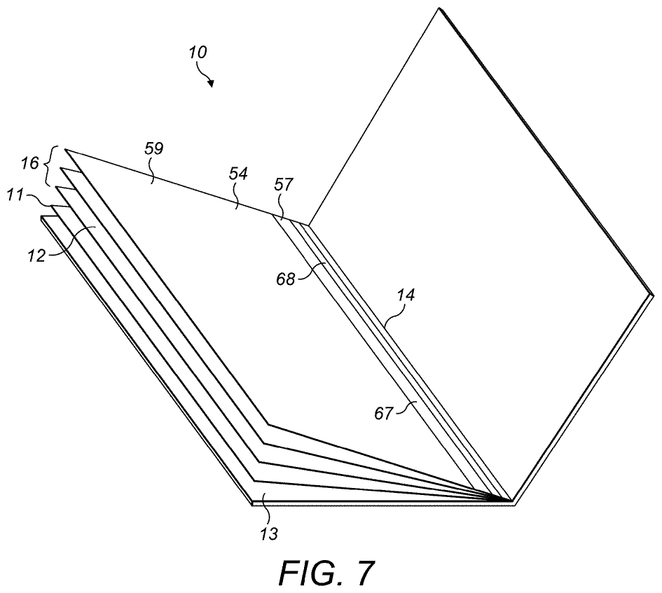

The first reinforcement layer 57 may comprise a base substrate 67 attached to the first leaf 54 and may comprise at least one spine security feature 68 (see FIGS. 6 and 7) located on or at least partially embedded in the base substrate 67. The base substrate 67 may provide the improved resistance to tear initiation whilst the at least one spine security feature 68 may provide an additional security function to the security document 10. Preferred embodiments of the first reinforcement layer 57 include:—
the first reinforcement layer 57 may comprise a tape, forming the base substrate 67, adhered to the first leaf 54. The tape is substantially tear resistant and may comprise a woven mesh, such as a fabric, in which the warp and weft are arranged to prevent tearing away from the fold line 14. The tape may comprise at least one of cotton, nylon, paper, polyurethane, rubber or the like. The tape may be approximately 100 μm thick;
the first reinforcement layer 57 may comprise a base substrate 67 comprising a polymer film or layer, which may be selected from any one of the polymers discussed above in respect of the first polymer substrate 20. In such an embodiment the first reinforcement layer 57 may be formed in a similar manner to any security thread known in the art (as discussed in further details below). Preferably the polymer film comprises PP or PE and it may be fused or adhered to the first leaf 54. In a particular embodiment the base substrate comprises an approximately 8 mm to approximately 10 mm wide PE strip having a thickness in the range of from approximately 23 μm to approximately 36 μm. In a particular embodiment the first reinforcement layer 57 comprises cross-laminated polyolefin. Preferably the polymer film is substantially transparent such that the first reinforcement layer 57 is not easily distinguishable to the human eye in visible light;
the first reinforcement layer 57 may comprise a base substrate 67 comprising a fibrous substrate (such as paper or cotton) adhered to the first leaf 54. As a result, the first reinforcement layer 57 may be a paper strip. The fibrous substrate may comprise a range of fibre types, including synthetic or natural fibres, or a mixture of both. A cellulose, wood and/or cotton based mixture is particularly suitable; or
the first reinforcement layer 57 may comprise a hybrid of the aforementioned base substrates 67. For example, as illustrated in FIG. 7, the first reinforcement layer 57 may comprise a base substrate 67 in the form of a polymer film, woven fabric or fibrous substrate and the at least one spine security feature 68 may comprise a polymer film in the form of a security thread. The arrangement of FIG. 7 is discussed in further detail below.

The at least one spine security feature 68 is preferably an overt feature which is clearly visible to a user of the security document 10. However at least one spine security feature 68 may be a covert feature, in that it is not distinguishable to the human eye in visible light and is instead machine readable or is viewable in non-visible (such as UV) light. Any of the security features and at least one first security device 30 in the first polymer page 11 may also be provided on the second side 52 of the first leaf 43, thereby at least partially forming the at least one spine security feature 68.

As illustrated in FIG. 6, the at least one spine security feature 68 may form indicia forming a serial number or the like. The at least one spine security feature 68 may have a perimeter forming any suitable shape, such as a recognisable pattern, indicium, alphanumeric character, symbol, logo (such as that of the issuing authority of the security document 10), graphic or the like. The term “recognisable” may refer to the shape conveying some form of intelligible information or data. In a particularly preferred embodiment the at least one spine security feature 68 may at least partially form the personal data 15. The at least one spine security feature 68 may also form microtext, fine line patterns or the like.

The at least one spine security feature 68 is preferably an overt security feature. The at least one spine security feature 68 preferably comprises at least one of the following materials and/or properties or combinations thereof:—
printed ink located on the base substrate 67. The ink may be luminescent, fluorescent, iridescent or the like. The ink may be applied by a printing process such as inkjet, UV cure inkjet, xerography, gravure, offset, flexographic, lithographic or the like. The printed ink may comprise, for example:—
   covert printed ink comprising an optically detectable material. The printed ink may be transparent such that it is not observable in visible light, but may be observed by the human eye and/or a machine via an optical detector such as a camera. The optical detection characteristic(s) of the material could include, for example, non-visible reflection or absorbance (such as UV or IR reflection or absorbance), a photoluminescent response such as fluorescence or phosphorescence (the stimulating radiation and/or the emitted radiation being unobservable in visible light), or the like. Alternatively, the printed ink may be observable in visible light but also capable of exhibiting such characteristics when exposed to non-visible light; or
   printed ink having optically variable properties, such as iridescence or iridescent amplitude interference materials, in which the appearance of the ink is different at different viewing angles. Such inks contain optically variable pigments having a colour shift between two distinct colours, with the colour shift being dependent on the viewing angle, are well known. The production of these pigments, their use and their characteristic features are described in, inter-alia, U.S. Pat. Nos. 4,434,010, 5,059,245, 5,084,351, 5,135,812, 5,171,363, 5,571,624, EP-A-0341002, EP-A-0736073, EP-A-668329, EP-A-0741170 and EP-A-1114102. In particular, the ink may exhibit colour shifting effects which are only substantially visible when the ink is viewed in reflected light against an opaque background. Suitable inks are disclosed in GB-A-2441261, the contents of which are incorporated herein by reference. The optically variable ink may comprise a magnetic optically variable pigment, which enables the creation of a further optical effect by having oriented magnetic pigments that generate dynamic and three dimensional-like images. Examples of such features include those disclosed in EP-A-1674282, U.S. Pat. No. 6,759,097, US-A-20040051297, US-A-20050106367, WO-A-2004007095, WO-A-2006069218, EP-A-1745940, and EP-A-1710756.
threads, strips, patches, foils, hot foils, laminates and the like located upon, partially embedded in or fully embedded in the base substrate 67. Such features are particularly preferred in the case of the base substrate 67 comprising fibrous substrate. A security thread is also particularly suitable and may be embedded or partially embedded in the fibrous substrate, for example, as disclosed in EP-A-0059056 or WO-A-2005/069231. The security thread may be located on the surface of the base substrate 67 as shown in FIG. 7, at least partially embedded in the base substrate 67 such that it comprises exposed regions separated by bridges (in the same manner as the security thread 36 as described above and shown in FIG. 1) or fully embedded in the base substrate 67. As is known in the art, the threads, strips, patches, foils, hot foils, laminates may include further security features therein or thereon, including:
   demetallised features, in which a layer of metal or the like is laid over the surface of the base substrate 67 and removed to form at least one spine security feature 68 in a predetermined shape. Alternatively, an opaque layer comprising any suitable material could be applied to the base substrate 67 and removed from localised areas to form at least one spine security feature 68 in a predetermined shape;
   iridescent amplitude interference materials, which display different colours at different viewing angles. Examples include thin-film interference structures, liquid crystal films, photonic crystals and the like. Thin film interference structures comprise repeating layers of different refractive indices; examples can include purely dielectric stacks (metal oxide or polymer) or those composed of alternate dielectric and metallic layers. Thin film interference structures are also known as Bragg stacks, as disclosed in WO-A-2015113143, or photonic crystal tunable materials, as disclosed in EP-A-2714411, or one dimensional photonic crystals. Such iridescent amplitude interference materials comprise two or more closely spaced interfaces, at least one of which partially reflects and partially transmits incident light such that the amplitude of the incident light is split. The transmitted portion is reflected at the second or subsequent interface(s) and interferes with the portion reflected from the first or earlier interface(s), leading to constructive interference of some wavelengths and destructive interference of others. As a result, the materials exhibit a characteristic colour which varies with viewing angle;
   diffractive or reflective/refractive relief structures which can be of any type and can exhibit any desired visual effect. Several such classes of diffractive based security devices exist. Two common types, both based on arrays of surface diffraction gratings, are the “Exelgram” developed by CSIRO (Commonwealth Scientific and Industrial Research Organisation), Australia and the Kinegram, developed by Landis and Gyr, Switzerland. These are described in WO-A-93/18419, WO-A-95/04948 and WO-A-95/02200 for the Exelgram and U.S. Pat. No. 4,761,253 and EP-A-0105099 for the Kinegram. Another type of diffractive device that can exhibit optical switching effects is a holographic structure manufactured using conventional interferential holographic techniques. A typical example of such a device used as a security device on a bank note is the multiple redundant hologram described in EP-A-0558574 where to maintain holographic efficiency the hologram uses spatially separated switching images In some embodiments the optically variable effect generating structure that may be implemented instead of, or as well as, a diffractive relief structure is a reflective and/or refractive relief structure (including thin film interference structures and the like) such as an array of facets which could be different types of prisms or pyramidal structures. Reflective elements such as facets can be configured to display different intensities (i.e. brightnesses) at different viewing angles;
   security devices which make use of focusing elements such as lenses, including moiré magnifier devices, integral imaging devices and so-called lenticular devices. Moiré magnifier devices (examples of which are described in EP-A-1695121, WO-A-94/27254, WO-A-2011/107782 and WO2011/107783) make use of an array of focusing elements (such as lenses or mirrors) and a corresponding array of microimages, wherein the pitches of the focusing elements and the array of microimages and/or their relative locations are mismatched with the array of focusing elements such that a magnified version of the microimages is generated due to the moiré effect. Each microimage is a complete, miniature version of the image which is ultimately observed, and the array of focusing elements acts to select and magnify a small portion of each underlying microimage, which portions are combined by the human eye such that the whole, magnified image is visualised. Integral imaging devices are similar to moiré magnifier devices in that an array of microimages is provided under a corresponding array of lenses, each microimage being a miniature version of the image to be displayed. However here there is no mismatch between the lenses and the microimages. Instead a visual effect is created by arranging for each microimage to be a view of the same object but from a different viewpoint. Lenticular devices on the other hand do not rely upon magnification, synthetic or otherwise. An array of focusing elements, typically cylindrical lenses, overlies a corresponding array of image sections, or “slices”, each of which depicts only a portion of an image which is to be displayed. Image slices from two or more different images are interleaved and, when viewed through the focusing elements, at each viewing angle, only selected image slices will be directed towards the viewer. Some examples of lenticular devices are described in U.S. Pat. No. 4,892,336, WO-A-2011/051669, WO-A-2011051670, WO-A-2012/027779 and U.S. Pat. No. 6,856,462; and
   venetian blind type devices (which utilise a masking grid in place of focusing elements) which utilise parallax between two overlapping grids to generate optically variable effects. An example is disclosed in WO97/047478.
where the base substrate 67 comprises a polymer film, the at least one spine security feature 68 can comprise any suitable feature usually incorporated into security threads as disclosed above. Such features are also commonly either incorporated into or applied onto the surface of secure documents such as banknotes;
laser markings, laser perforations, embossings and the like in or through the base substrate 67;
in the case of the base substrate 67 comprising a fibrous substrate, any associated security features, such as watermarks, electrotype watermarks, security fibres, planchettes and the like;
antenna, electronic chips and the like;
one or more windows in which the base substrate 67 is substantially transparent such that the first leaf 54 is visible through the windows;
machine readable materials could be incorporated into the base substrate 67 using any known technique such as printing, embedding directly in the substrate or incorporating within an additional element such a thread or laminate layer. The machine readable materials may contain detectable materials that react to an external stimulus, which may include but are not limited to fluorescent, phosphorescent, infrared absorbing, thermochromic, photochromic, magnetic, electrochromic, conductive and piezochromic materials; and/or
the at least one opacifying layer 22, 23 may extend over the base substrate 67 and the at least one spine security feature 68 may be formed as any of the above in or on the at least one opacifying layer 22, 23. One or more of the first and second opacifying layers 23, 24 may be laser ablated without damaging the first polymer substrate 20 using the method disclosed in EP-A-0961690.

The reinforcement arrangement 50 may further comprise a second reinforcement layer 58 which, as illustrated in FIG. 5, may be attached to the second leaf 55. In a similar manner to the first reinforcement layer 57, the second reinforcement layer 58 may comprise a tape adhered to the fibrous substrate 17 of the second leaf 55 or may comprise any other of the arrangements discussed herein in respect of the first reinforcement layer 57. The second reinforcement layer 58 may be omitted in other embodiments.

The first and second leaves 54, 55, first and second reinforcement layers 57, 58 and further leaves 56 are stitched together along the fold line 14 to form the security document 10. Preferably at least part of the first reinforcement layer 57 may be visible in the security document 10 such that it forms a security feature. Alternatively, at least part of or all of the first reinforcement layer 57 may be hidden. As a result, at least one spine security feature 68 may be hidden when the security document 10 is opened, thereby making it a covert security feature. The at least one spine security feature 68 may therefore be machine readable, such as by comprise magnetic inks or the like, that can be detected by a machine through the cover 13.

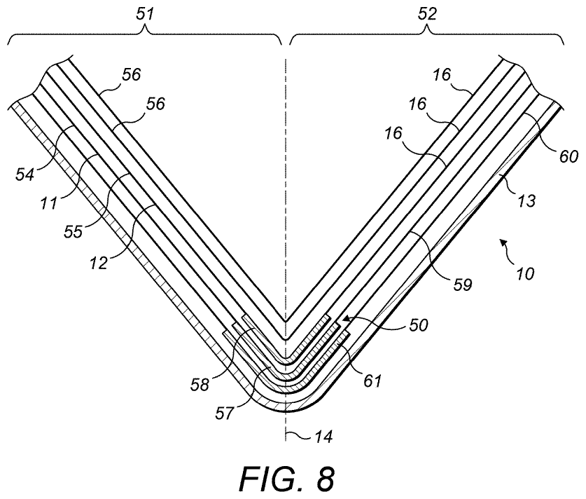

As illustrated in FIG. 8, an outer leaf 60 formed of fibrous substrate and/or polymer substrate is stitched to the outside of the first leaf 54 such that it is located between the first leaf 54 and cover 13. An outer reinforcement layer 61, which may be adhesive tape or any other of the arrangements discussed herein in respect of the first reinforcement layer 57, may be attached to the outer leaf 60 about the fold line 14. The outer reinforcement layer 61 is preferably attached to the outer surface of the outer leaf 60 as illustrated in order to protect the stitch line 14 as in EP-B-2004421. However, in alternative embodiments the outer reinforcement layer 61 is attached to the inner surface of the outer leaf 60. The outer leaf 60 and outer reinforcement layer 61 may then be adhered to the cover 13 to form the booklet. Preferably the entire outer leaf 60 is adhered across the entire cover 13 so that they are substantially indistinguishable from one another and the stitch line is entirely embedded within the cover 13 and outer leaf 60. The outer leaf 60 may also be referred to as the “end page” of the security document 10.

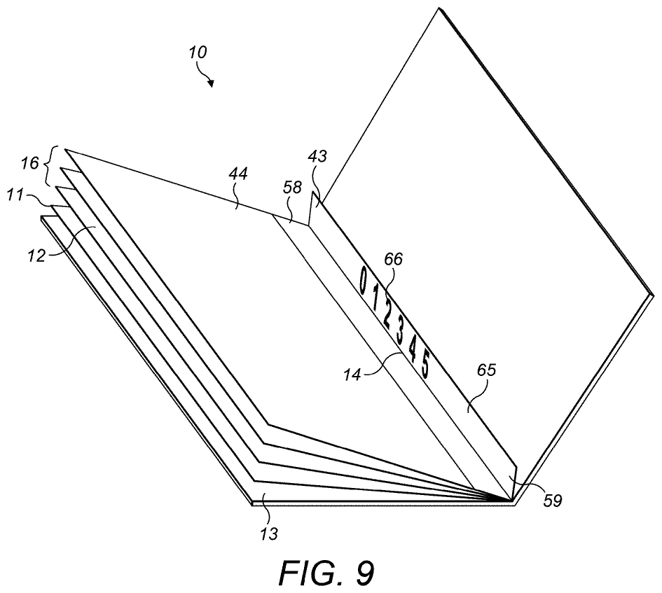

In FIGS. 5 to 8 the first leaf 54 extends away from the fold line 14 and across the entire width of the cover 13 and visa pages 16. Since it is difficult for border authorities to stamp ink and/or attach visa sheets to the first polymer substrate 20 and at least one opacifying layer 23, 24, the first leaf 54 may not extend across the entire second side 52. FIG. 9 illustrates a particular embodiment in which the first leaf 54 extends no further than the edge of the first reinforcement layer 57 on the second side 52 and forms a tab 65. The tab 65 may extend from the fold line 14 by up to a half of, and more preferably up to a quarter of, the width of the visa pages 16 and/or cover 13. For example, the tab 65 may extend from the fold line 14 by up to approximately 1 mm to approximately 15 mm. In this embodiment the first reinforcement layer 57 may extend along the first leaf 54 from the fold line 14 on the first side 51 of by up to one half of, or more preferably up to one quarter of, the extension of the first leaf 54 away from the fold line 14 on the first side 51. The first reinforcement layer 57 extends along substantially all of the first leaf 54 on the second side.

The tab 65 may comprise at least one tab security device 66 formed from the at least one spine security feature 68. For example, as illustrated in FIG. 9, the tab security device 66 may comprise a series of elements forming indicia. The illustrated indicia may be formed by laser marking the first polymer substrate 20 and/or at least one opacifying layer 23, 24 of the tab 65 or by printing ink thereon. The tab security device 66 may also be formed in a similar manner to any of the embodiments of the first security device 30 or at least one spine security feature 68 as discussed herein.

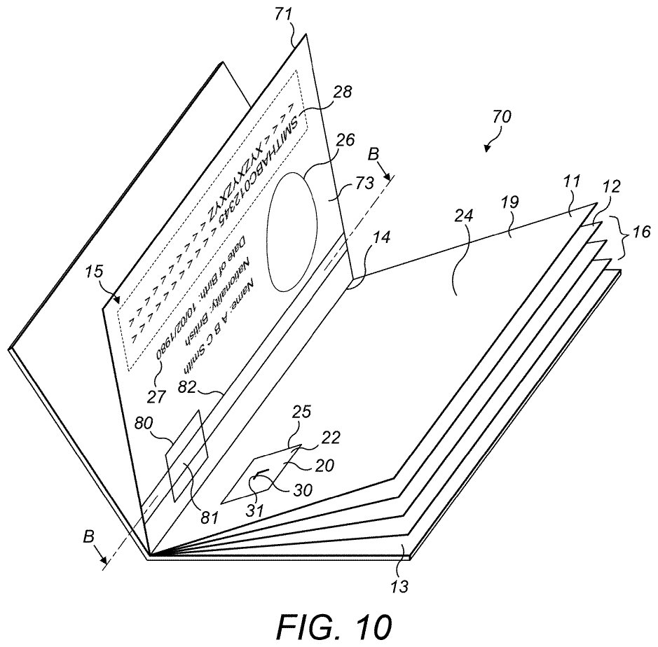

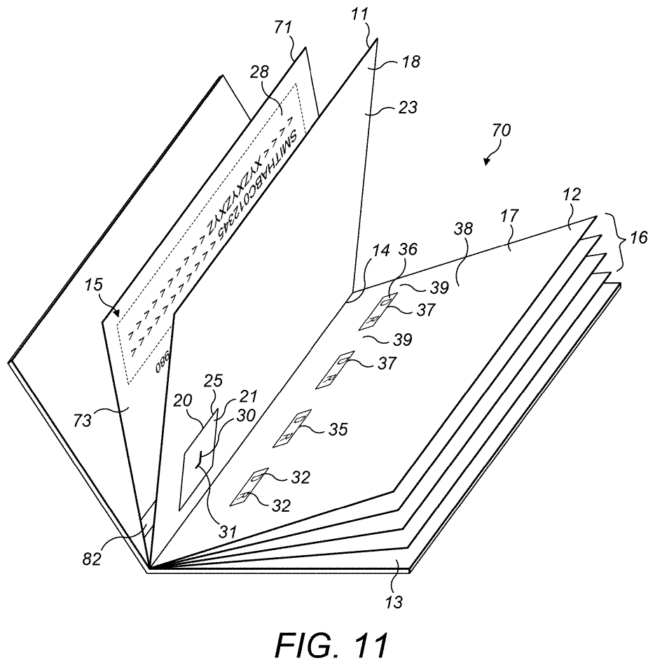

FIGS. 10 to 13 illustrate a further embodiment of the present invention in which a security document 70 comprises a second polymer page 71, preferably located between the first polymer page 11 and cover 13. FIGS. 10 to 13 contain, where appropriate, reference numerals corresponding to those used in FIGS. 1 to 4. Preferably, as illustrated, the second polymer page 71 is the data page and comprises the personal data 15.

The second polymer page 71 preferably has a different composition to that of the first polymer page 11. In particular, the compositions of the first and second polymer pages 11, 71 may differ in structure and/or materials. Preferably the first polymer page 11 is a flexible film, whilst the second polymer page 71 is a rigid sheet. As a result, different techniques are required to create each of the first and second polymer pages 11, 71 and the difficulty of counterfeiting is increased. The different composition may result from differing materials, arrangements of opacifying layers, thicknesses, rigidities and abilities to contain security features. In a particularly preferred embodiment the first polymer page 11 comprises a first polymer substrate 20 formed from a single layer and at least one outer opacifying layer 23, 24 on its first and/or second substrate surface 21, 22 whilst the second polymer page 71 is formed from a plurality of plastic layers fused together.

The second polymer page 71 preferably comprises a substantially rigid second polymer substrate 72 or “plastic substrate” having a first outer surface 73 and a second outer surface 74. Each of the first and second outer surfaces 73, 74 is preferably substantially flat and planar. The second polymer substrate 72 is formed from a plurality of layers which are fused together into a substantially non-laminar or unitary structure. The second polymer substrate 72 preferably comprises a different synthetic polymer, which is preferably non-fibrous, to that of the first polymer substrate 20. The second polymer substrate 72 may be a thermoplastic polymer such as polycarbonate, polyester, polyethylene, polypropylene or polyvinyl chloride. Polycarbonate is particularly suitable due to its high durability, its ease of manufacture and the ease with which security features can be incorporated within it.

The thickness of the second polymer substrate 72, which is the distance between the first and second outer surfaces 73, 74, is preferably at least approximately 150 μm and more preferably at least approximately 300 μm. In particular, the second polymer substrate 72 may be between approximately 300 μm and approximately 1000 μm thick, more preferably between approximately 600 μm and approximately 800 μm thick and, for example, may be approximately 300 μm or approximately 800 μm thick. The second polymer substrate 72 is substantially thicker and more rigid than the first polymer substrate 20. In a particular, the second polymer substrate 72 is at least twice the thickness, and more preferably at least three times the thickness of the first polymer substrate 20. The adjacent page 12 is preferably thinner than the second polymer page 71 and thicker than the first polymer page 11.

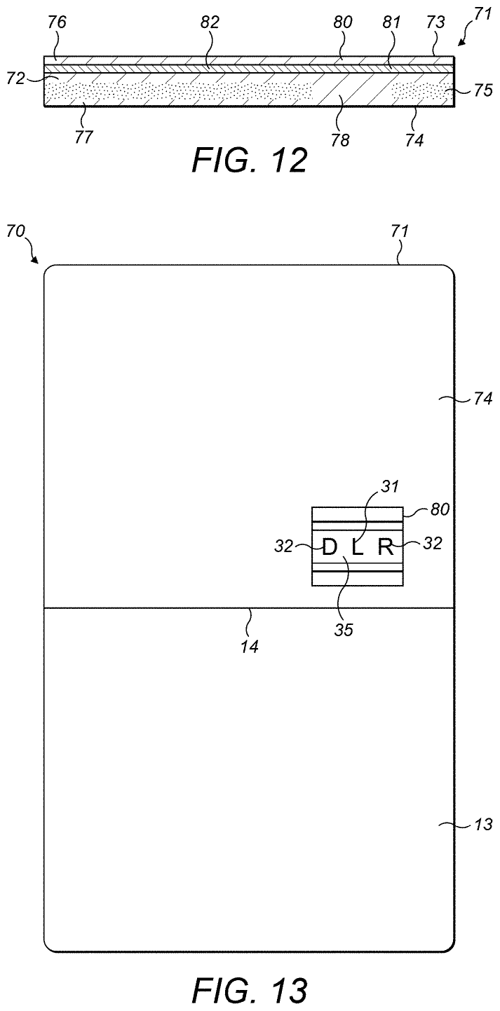

As illustrated in FIG. 12, the second polymer substrate 72 preferably comprises a substantially opaque region 75 within its thickness and separated from the first and second outer surfaces 73, 74 by first and second substantially transparent regions 76, 77. The opaque region 75 at least partially borders at least one third substantially transparent region 78. The first, second and third transparent regions 76, 77, 78 form at least one window 80 through the second polymer substrate 72. In the illustrated embodiment a single, square window 80 extends through the thickness of the second polymer substrate 72.

The personal data 15 may be formed by a series of laser markings or engravings within the second polymer substrate 72 in the first transparent region 76 between the opaque region 75 and the first outer surface 73. The laser markings are preferably visible when the first outer surface 73 is viewed in reflected light incident upon the first outer surface 73 by virtue of the first transparent region 76 in which they are located. The second polymer substrate 72 may also comprise any other suitable security feature, such as a hologram in the form of non-variable data, UV responsive features, optically variable features, windowed or transparent features, antenna, electronic chips and laser-perforations.

The second polymer page 71 may further comprise a third security device 81 disposed in or on the second polymer substrate 72 and at least partially in the at least one window 80. In the illustrated embodiment the third security device 81 comprises a security thread 82 located in the first transparent region 76 between the opaque region 75 and the first outer surface 73.

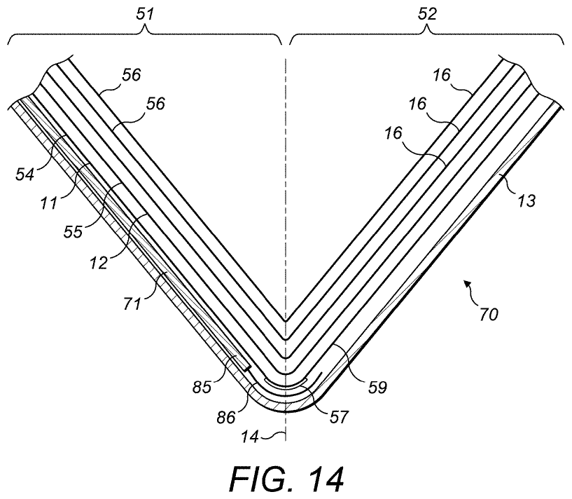

As shown in FIG. 14, the security document 70 comprises a first side 51 and a second side 52 on either side of the fold line 14 about which the first and second sides 51, 52 can be rotated and brought together. The security document 70 comprises a first leaf 54, which comprises the first polymer page 11 at the first side 51, and a second leaf 55 inwards of the first leaf 54, which comprises the adjacent page 12 on the first side 51 and a visa page 16 on the second side 52. Further leaves 56 are located inwards of the second leaf 55 and form further visa pages 16 on the first and second sides 51, 52. In FIG. 14 a third leaf 85 is located between the first leaf 54 and the cover 13. FIG. 14 illustrates the leaves 54, 55, 56, 85 and cover 13 in an exploded configuration and in the constructed security document 70 they may be stitched together along a stitch line along the fold line 14. However, in a preferred embodiment the security document 70 comprises an outer leaf 60 or end page, adhered to the cover 13, and the third leaf 85 may be located between the first leaf 54 and the outer leaf 60.

The third leaf 85 comprises the second polymer page 71 and a connection tab 86 extending from the second polymer page 71. The stitch line 14 passes through the connection tab 86. The connection tab 86 may be substantially thinner and/or more flexible than the second polymer substrate 72. As described in further detail below, the connection tab 86 may comprise the same plastic as that forming the second polymer substrate 72 of the second polymer page 71 and may be formed by one of the plurality of layers forming the second polymer page 71 extending beyond its inner edge (i.e. the edge adjacent to the fold line 14). Alternatively a fabric, such as a woven mesh, is suitable. EP-B-1592565 discloses a particularly suitable method of forming a connection tab 86 of a flexible and bending resistant material, such as overlying layers of PE and PET. The connection tab 86 may extend into the second side 52 of the security document 70 from the fold line 14 by up to approximately 2 mm to approximately 20 mm.

In an alternate embodiment, the material of the connection tab 86 may be selected to enable the connection tab 86 to be attached, for example by an adhesive, welding or the like, to the first leaf 54 in an attachment region. The connection tab 86 may comprise any other material discussed above in respect of the first reinforcement layer 57 and which can be integrated with the second polymer page 71 during manufacture. The second opacifying layer 24 may not extend across the first leaf 54 in the attachment region in order to ensure an adequate surface area for locating adhesive between the first polymer substrate 20 and connection tab 86. Thus the fold line 14 comprises stitches through the attachment region, connection tab 86 and the first leaf 54. In this manner the first reinforcement layer 57 may, therefore, comprise the attachment region. The attachment region may extend into the second side 52 of the security document 70 from the fold line 14 by up to approximately 2 mm to approximately 20 mm. The attachment region may also extend along the first polymer page 11 by up to approximately 2 mm to approximately 20 mm. A counterfeiter may, therefore, have to detach both the first and second polymer pages 11, 71 along the attachment region if they wish to swap or change one of them to counterfeit the personal data 15 thereon.

The first polymer page 11, adjacent page 12, plurality of visa pages 16, cover 13 and, if present, second polymer page 71 are generally formed separately before being attached together along the fold line 14 to form the security document 70. The personal data 15 is preferably applied after the rest of the security document 10, 70 has been assembled to complete the data page.

The first polymer page 11 may be manufactured by creating a web of first polymer substrate 20, applying the at least one opacifying layer 23, 24 to the first polymer substrate 20, adding the at least one first security device 30 to the at least one opacifying layer 23, 24 and/or first polymer substrate 20, splitting and/or cutting the web into a plurality of first leaves 54 and, if required, attaching or forming the first reinforcement layer 57. The first reinforcement layer 57 may be applied at suitable locations to the web and be cut at a cutting station. Alternatively, the first reinforcement layer 57 may be applied to each individual first leaf 54 after cutting.

The adjacent page 12 is preferably produced in a similar manner to the method disclosed in EP-A-0059056 or WO-A-2005/069231, the contents of which are incorporated herein by reference, in order to incorporate the second security device 35 in the form of the security thread 36 into the fibrous substrate 17. The fibrous substrate 17 is formed by depositing fibres on to a support surface to form a layer of the fibrous substrate, couching the fibrous substrate layer from the support surface and drying the layer of fibrous substrate.

The second polymer page is generally manufactured by forming an insert, forming a plurality of plastic layers including the insert and second security device 35 therein and laminating the plurality of plastic layers together in a laminator to form the second polymer substrate 72.

The connection tab 86 may be formed by any means known as the art, for example as described in EP-B-1592565. One or more of the plurality of plastic layers may be wider than the rest of the plurality if plastic layers such that it extends from the formed second polymer substrate 72 and forms the connection tab 86. Alternatively, a fabric or the like may be located between two of the plurality of plastic layers and fused therein during lamination. A strip of substantially transparent plastic may initially be cut by a punching tool to form a plurality of inserts before or during the arrangement of the plurality of plastic layers. The shape of the perimeter of each insert forms the shape of the perimeter of each window 80. During the lamination process each of the plurality of plastic layers and insert become at least softened or semi-molten (i.e. a liquid of relatively high viscosity) so that the plastic flows and mixes together across the interfaces between them.

The first leaf 54, second leaf 55, third leaf 85, further leaves 56 and/or cover 13 are bound along the fold line 14, for example by stitching, with the cover 13 to form the security document 10, 70. Furthermore, in a preferred embodiment, an outer leaf 60 or end cover may be adhered to the cover 13 between the leaves 54, 55, 56, 85 and the cover 13. In all embodiments the outer leaf 60 may not comprise the outer reinforcement layer 61. Suitable stitching processes include those discussed WO-A-2011/151638, the contents of which are incorporated herein by reference.

The personal data 15 relating to the holder of the security document 10, 70 is preferably applied after the binding step. However, it is possible to apply the personal data 15 before the binding and during any stage of the aforementioned manufacturing processes. The personal data 15 is provided in or on the first polymer pages 11, the second polymer page 71, the adjacent page 12 and/or the first reinforcement layer 57 to form one or more data pages. In some embodiments the personal data 15 may be partially located on two or three of the first polymer page 11, the adjacent page 12, the second polymer page 71 and/or the first reinforcement layer 57. Some or all of the personal data 15, for example the holder's portrait 26, may be repeated on each of the first polymer page 11, adjacent page 12, second polymer page 71 and/or the first reinforcement layer 57. Preferably the personal data 15 is applied to each of the first polymer page 11, the adjacent page 12, the second polymer page 71 and/or the first reinforcement layer 57 by different application techniques such that it has different compositions.

Various alternatives to those described above also fall within the scope of the present invention. The security document 10, 70 may be of any suitable type having both the first polymer, second polymer and/or adjacent pages 11, 12, 71, and thus is preferably in a booklet format. In particular, the security document 10, 70 is a passbook, an identification document, a certificate, a license, a cheque book and the like. Particularly preferably the security document 10, 70 is a passport, in that it is an official document issued by a government which certifies the holder's identity and citizenship and entitles them to travel across borders between countries. The passport may meet the requirements set out in Document 9303 issued by ICAO.

The security document 10 may comprise a plurality of each of the first and/or second polymer pages 11, 71 and may not comprise any adjacent pages 12 comprising fibrous substrate 17. The plurality of first and/or second polymer pages 11, 71 may each comprise the same or different first and third security devices 30, 81 arranged to interact with one another in windows 25, 80 which overlie one another when the plurality of first and/or second polymer pages 11, 71 are adjacent to one another.

Furthermore, the sequence of the first polymer page 11, adjacent page 12 and, if present, second polymer page 71 in the security document 10, 70 may differ to that set out above. For example, the second polymer page 71 comprising the second polymer substrate 72 may be located between the adjacent page 12 and the first polymer page 11 comprising the first polymer substrate 20. In any embodiment the security document 10, 70 may comprise an outer leaf 60 of fibrous substrate 17 adjacent to or adhered to the cover 13. The sequences illustrated in FIGS. 5 and 14 are preferable as they improve the ease of manufacture of the security document 70 by enabling the binding of the first leaf 54, second leaf 55 and further leaves 56 prior to the addition of the third leaf 85.

1. A security document comprising at least two leaves attached together along a fold line and a cover located on the outside of the at least two leaves, wherein the at least two leaves comprise:
a first leaf comprising a first polymer substrate,
a first reinforcement layer is attached or formed with the first leaf, the first reinforcement layer being a strip extending along the first leaf at least partially along the fold line and at least partially away from the fold line on both sides of the fold line; and
an outer leaf located between the first leaf and the cover.

2. A security document as claimed in claim 1 wherein the at least two leaves are attached together along the fold line by a plurality of stitches.

3. A security document as claimed in claim 1 wherein the first reinforcement layer and first leaf together have a higher resistance to tear initiation from the fold line than the first leaf alone.

4. A security document as claimed in claim 1 wherein the first reinforcement layer is adhered, welded and/or fused to the first leaf.

5. A security document as claimed in claim 1 wherein the first reinforcement layer comprises at least one of a tape, a woven mesh, a woven fabric, a polymer film, a security thread and a fibrous substrate.

6. A security document as claimed in claim 1 wherein the first reinforcement layer comprises at least one spine security feature.

7. A security document as claimed in claim 6 wherein the first reinforcement layer comprises a base substrate and the at least one spine security feature is located on or at least partially embedded in the base substrate.

8. A security document as claimed in claim 6 wherein at least one spine security feature is visible when the security document is open.

9. A security document as claimed in claim 6 wherein at least one spine security feature is hidden when the security document is open.

10. (canceled)

11. (canceled)

12. (canceled)

13. A security document as claimed in claim 1 wherein the first leaf comprises a first polymer page on a first side of the fold line and a further polymer page on a second side of the fold line, the first polymer page comprising personal data.

14. A security document as claimed in claim 13 wherein the further polymer page comprises a tab, which is smaller than the first polymer page and comprises the first reinforcement layer, on a second side of the fold line.

15. (canceled)

16. (canceled)

17. A security document as claimed in claim 1 wherein the outer leaf is adhered to the cover.

18. A security document as claimed in claim 1 further comprising a second reinforcement layer attached to a second leaf, the second reinforcement layer extending at least partially along the fold line and at least partially away from the fold line.

19. A security document as claimed in claim 1 wherein the first polymer substrate comprises a flexible film and/or at least one opacifying layer on at least one surface of the polymer substrate.

20. (canceled)

21. A security document as claimed in claim 1 comprising a third leaf attached to the first leaf along the fold line, the third leaf comprising a second polymer substrate and a connection tab extending from the second polymer substrate.

22. (canceled)

23. (canceled)

24. (canceled)

25. A security document as claimed in claim 21 wherein the connection tab is thinner and/or more flexible that the second polymer substrate.

26. A security document as claimed in claim 21 wherein the connection tab is attached to the first leaf through the first reinforcement layer along the fold line by a plurality of stitches.

27. (canceled)

28. A method of manufacturing a security document, the method comprising:
forming a first leaf comprising a first polymer substrate;
attaching to or forming with the first leaf a first reinforcement layer;
attaching the first leaf to at least one further leaf along a fold line; and
locating a cover on the outside of the first leaf and at least one further leaf, the at least one further leaf comprising an outer leaf located between the first leaf and the cover,
wherein the first reinforcement layer is a strip and extends along the first leaf at least partially along the fold line and at least partially away from the fold line on both sides of the fold line.

29. A method as claimed in claim 28 wherein the first leaf is attached to the at least one further leaf along the fold line by stitching.

30. A method as claimed in claim 28 wherein the first reinforcement layer is attached to or formed with the first leaf by welding or adhesive.

31. (canceled)

32. (canceled)

33. (canceled)
